(19) United States
(12) Patent Application Publication
(10) Pub. No.: US 2003/0226447 A1
(43) Pub. Date: Dec. 11, 2003

(54) Beverage flavor enhancing device and associated methods

(76) Inventor: Kenneth E. Flick, Douglasville, GA (US)

Correspondence Address: CHRISTOPHER F. REGAN, ESQUIRE, ALLEN, DYER, DOPPELT, MILBRATH & GILCHRIST, P.A., P.O. Box 3791, Orlando, FL, 32802-3791, US

(21) Appl. No.: 10/164,750

(22) Filed: Jun. 6, 2002

(51) Int. Cl. A23C 3/00

(52) U.S. Cl. 99/275; 99/279

(57) ABSTRACT

A beverage flavor enhancing device for use with a beverage container includes a base and a plurality of tubular members extending upwardly from the base and arranged in spaced-apart relation to receive the beverage container therebetween when the beverage container is positioned on the base. At least one permanent magnet is carried by each of the tubular members to generate a magnetic field within the beverage container to thereby enhance the beverage flavor.

### FIELD OF THE INVENTION

The present invention relates to the field of beverage treatment, and, more particularly, to the field of magnetic treatment of beverages to enhance flavor and associated methods.

### BACKGROUND OF THE INVENTION

It is recognized that the flavor of some beverages may be enhanced by exposure to a magnetic field, which alters the molecular properties. U.S. Pat. No. 6,287,614 to Peiffer, for example, describes reducing the sensory perception of acids and tannins in alcoholic beverages by treating the beverage with a magnetic field. This treatment is asserted to give the alcoholic beverage a more aged flavor.

Accordingly, a number of products have been developed to expose beverages to magnetic fields to enhance flavor. Some of these products also attempt to enhance user convenience when magnetically treating beverages. For example, U.S. Pat. No. 4,872,401 to Lee discloses a container including surrounding sidewalls that have a plurality of magnets mounted on the inner side of the surrounding sidewalls to improve the flavor of fermented substances, such as wine, sauce, and tobacco. Another example is illustrated in U.S. Pat. No. 6,390,319 to Yu which discloses a beverage magnetizing container that exposes a beverage within the container to a magnetic field to promote preservation. The magnetic field is created by permanent magnets in either the sidewalls, base, or cap of the container.

Other products magnetically treat beverages during initial processing. For example, U.S. Pat. No. 6,325,942 to Freije, III discloses a liquid treatment unit that includes a pipe having a plurality of magnets coupled thereto. As liquid passes through the pipe, it is treated by the magnets to alter the molecular structure. U.S. Pat. No. 5,860,353 to Ceccarani discloses an apparatus for accelerating the aging of alcoholic beverages. The apparatus exposes beverages to low-frequency polarized pulsating magnetic fields.

One shortcoming with several of these devices is that the container with its integral magnets must contact the beverage to be treated. In other words, the user must pour the beverage to be treated into the specialized container for treatment prior to consuming the beverage. These specialized containers may increase the cost of magnetically treating a beverage and decrease consumer flexibility.

### SUMMARY OF THE INVENTION

In view of the foregoing background, it is therefore an object of the present invention to provide a device and methods for magnetically treating beverages that enhance consumer ease and flexibility.

This and other objects, advantages, and features of the present invention are provided by a beverage flavor enhancing device for use with a beverage container. The beverage flavor enhancing device may comprise a base and a plurality of tubular members extending upwardly from the base and arranged in spaced-apart relation to receive the beverage container therebetween when the beverage container is positioned on the base. The device may also comprise a permanent magnet within each of the tubular members to generate a magnetic field within the beverage container to thereby enhance the beverage flavor. In other words, the treatment device can be readily used to treat a number of typical beverage containers, such as drinking glasses, to increase convenience and flexibility for the users.

The tubular members may be arranged along points of an imaginary cylinder sized to receive the beverage container. The tubular members may further be at least three in number.

The base may have a generally polygonal shape, and the tubular members may be positioned adjacent respective vertices of the polygonally shaped base. The polygonal shape may be a square or an equilateral triangle, for example. In one embodiment, the tubular members may be fixed to the base. More particularly, the tubular members may be integrally formed with the base as a monolithic unit.

In another embodiment, the tubular members may be slidably positioned on the base to facilitate repositioning thereof to accommodate different sized beverage containers. The base may include elongated slots formed therein to slidably receive respective ends of the tubular members. Each slot and respective end may form an elongated dovetail joint. This advantageously allows treatment of beverages in many different sized containers to thereby enhance consumer ease and flexibility.

The base and the tubular members may comprise non-magnetic material, such as plastic, for example. The permanent magnets may comprise neodymium.

A method aspect of the invention is for enhancing beverage flavor. The method may include providing a device comprising a base, a plurality of spaced-apart tubular members extending upwardly from the base, and at least one permanent magnet within each of the tubular members. The method may also include positioning a beverage container on the base and between the spaced-apart tubular members to expose a beverage in the beverage container to a magnetic field to thereby enhance beverage flavor.

### BRIEF DESCRIPTION OF THE DRAWINGS

FIG. 1 is a perspective view of the beverage flavor enhancing device according to the present invention.

FIG. 2 is a top plan view of the beverage flavor enhancing device shown in FIG. 1.

FIG. 3 is a cross-sectional view of the beverage flavor enhancing device taken along line 3-3 in FIG. 2.

FIG. 4 is a perspective view of another embodiment of the beverage flavor enhancing device according to the present invention.

FIG. 5 is a top plan view of the beverage flavor enhancing device shown in FIG. 4.

FIG. 6 is a perspective view of yet another embodiment of the beverage flavor enhancing device according to the present invention.

FIG. 7 is a top plan view of the beverage flavor enhancing device shown in FIG. 6.

FIG. 8 is a cross-sectional view of the beverage flavor enhancing device taken along line 8-8 in FIG. 7.

FIG. 9 is a cross-sectional view of a tubular member of the beverage flavor enhancing device taken along line 9-9 in FIG. 8.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and double prime notation are used to indicate similar elements in alternative embodiments.

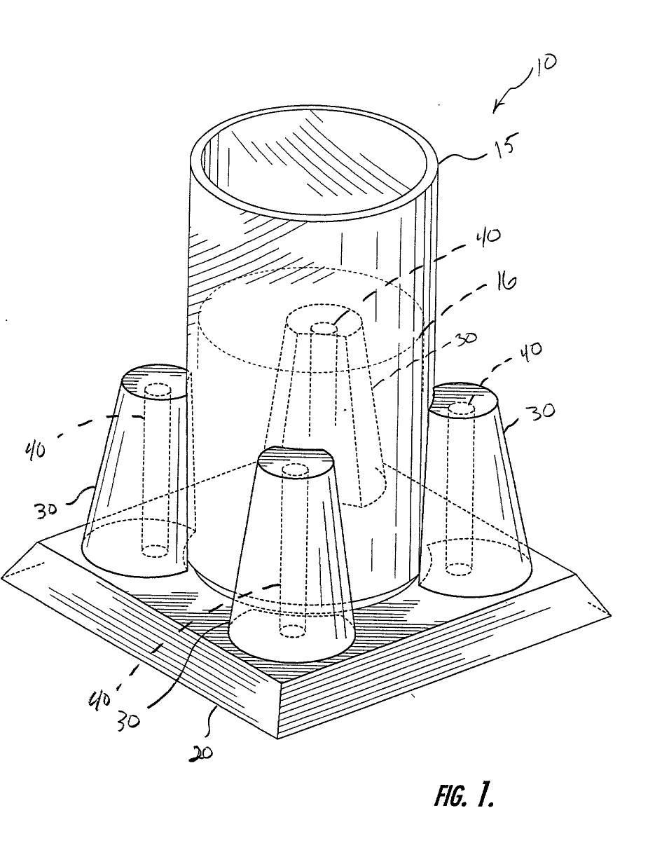

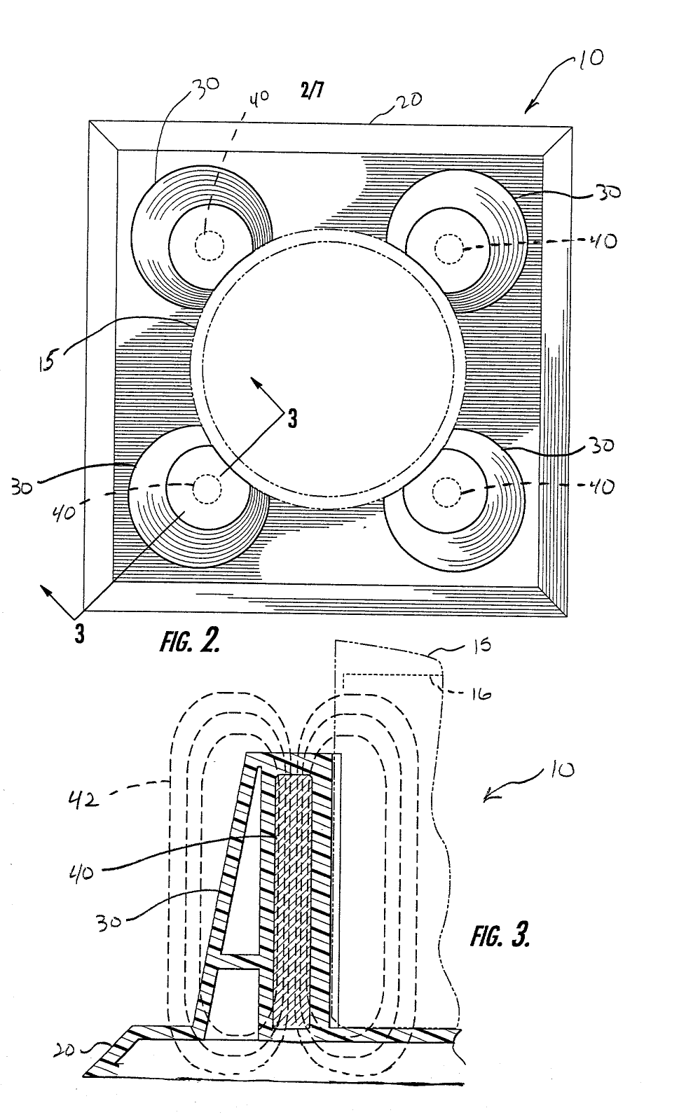

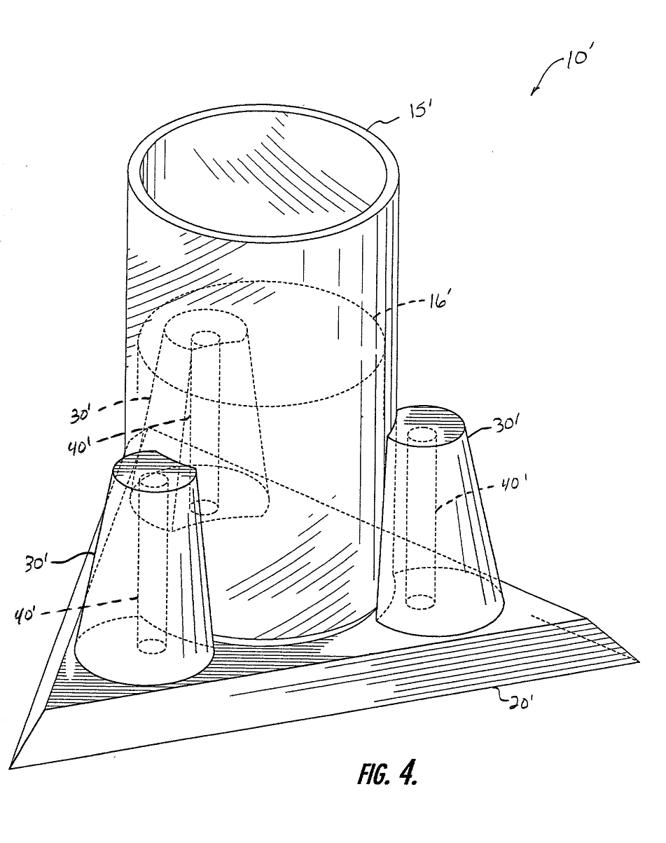

Referring initially to FIGS. 1-3, a beverage flavor enhancing device 10 for use with a beverage container 15 is now described. The beverage flavor enhancing device 10 illustratively includes a base 20 and a plurality of tubular members 30 extending upwardly from the base. The tubular members 30 are arranged in spaced-apart relation to illustratively receive the beverage container 15 therebetween when the beverage container is positioned on the base 20.

The device 10 also includes a permanent magnet 40 within each of the tubular members 30 to illustratively generate a magnetic field 42 within the beverage container 15 and, more particularly, within the beverage 16 in the container. The magnetic field 42 treats the beverage 16 within the beverage container 15 to enhance the beverage flavor. The beverage container 15 may, for example, be a shot glass, or any other nonferrous container that permits the external magnetic field 42 to penetrate into the beverage 16. In other embodiments, the device 10 could be sized for a standard 12-ounce aluminum can, a wine bottle, a liquor bottle, a juice box, a milk carton, or any other type of beverage container as understood by those skilled in the art. The device 10 is preferably used to enhance the flavor of alcoholic beverages, but may also be used to enhance the flavor of citrus juice and dairy products, for example. It will be understood by those skilled in the art that a beverage 16 includes any liquid consumable substance, such as the above-referenced citrus juice, dairy products, and alcoholic beverages as well as sauces and soups, for example.

The tubular members 30 are illustratively arranged along points of an imaginary cylinder sized to receive the beverage container 15. In the illustrated embodiment, the tubular members 30 are fixed to the base 20. The tubular members 30 are illustrated as having a frusto-conical shape wherein an end having a larger diameter is positioned adjacent the base 20. The tubular members 30 also illustratively include a recess formed therein to receive arcuate portions of a beverage container 15. The tubular members 30 can have other interior and exterior shapes as well. For example, the shapes may be oval, elliptical, generally polygonal, square, triangular, hexagonal, octagonal, rectangular, etc. as will be appreciated by those skilled in the art.

The base 20 and the tubular members 30 are integrally formed as a monolithic unit in some embodiments. Each of the tubular members 30 illustratively includes a permanent magnet 40 therein. The permanent magnet 40 may be a plurality of permanent magnets. A magnetic field 42 is created by the permanent magnets 40 so that the beverage 16 within a beverage container 15 is exposed to the magnetic field when the beverage container is positioned between the tubular members 30.

The base 20 and the tubular members 30 may comprise nonmagnetic material, such as plastic material, for example. It will be understood by those skilled in the art that any nonmagnetic material may be used to form the base 20 and tubular members 30 of the beverage flavor enhancing device 10. The permanent magnets 40 preferably comprise neodymium, but may be provided by any magnetic material, such as a ceramic block magnet, alnico, and samarium cobalt, as understood by those skilled in the art.

The base 20 illustratively has a generally polygonal shape. The polygonal shape in the embodiment illustrated in FIGS. 1-3, for example, is square. In other embodiments, the base 20 may include other polygonal shapes as understood by those skilled in the art.

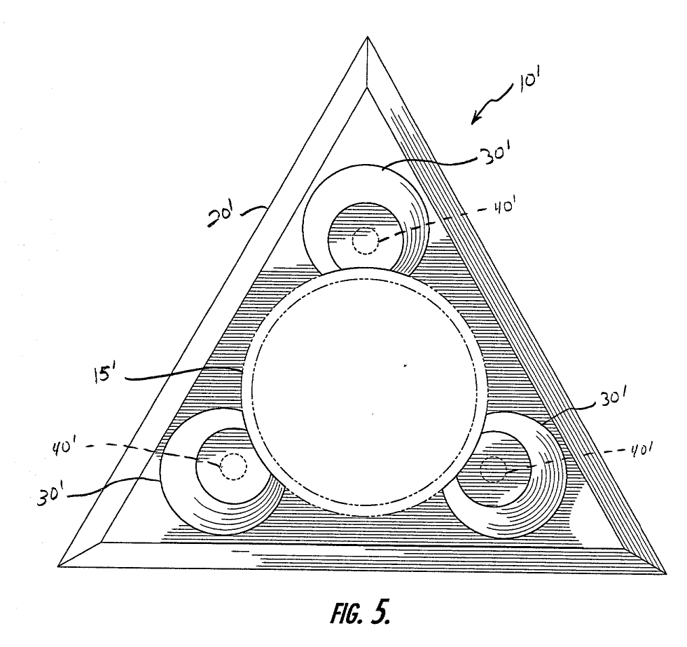

Turning now to FIGS. 4-5, another embodiment of the beverage flavor enhancing device 10′ is now described. The tubular members 30′ illustratively comprise three tubular members and are positioned adjacent respective vertices of the triangularly shaped base 20′. A permanent magnet 40′ is positioned within each of the tubular members 30′ to create a magnetic field 42′ within the beverage container 15′ and enhance the flavor of the beverage 16′ positioned therein. In this embodiment of the device 10′, the polygonal shape of the base 20′ is an equilateral triangle. In the illustrated device 10′, the beverage container 15′ fits closely within the tubular members 30′. The beverage container may, however, be smaller in diameter while the beverage 16′ positioned therein still experiences the flavor enhancing effects caused by the magnetic field 42′ from the permanent magnets 40′.

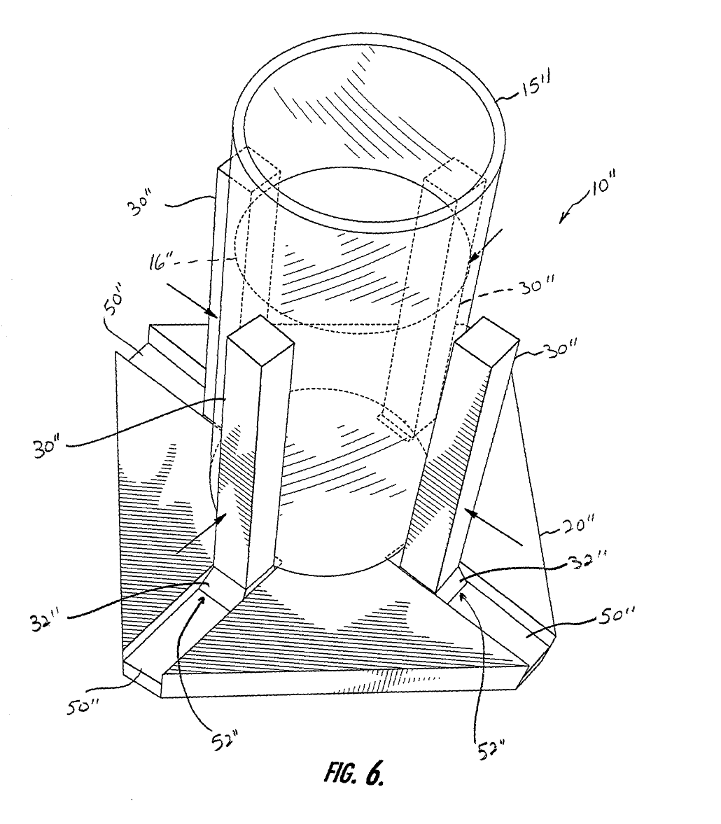

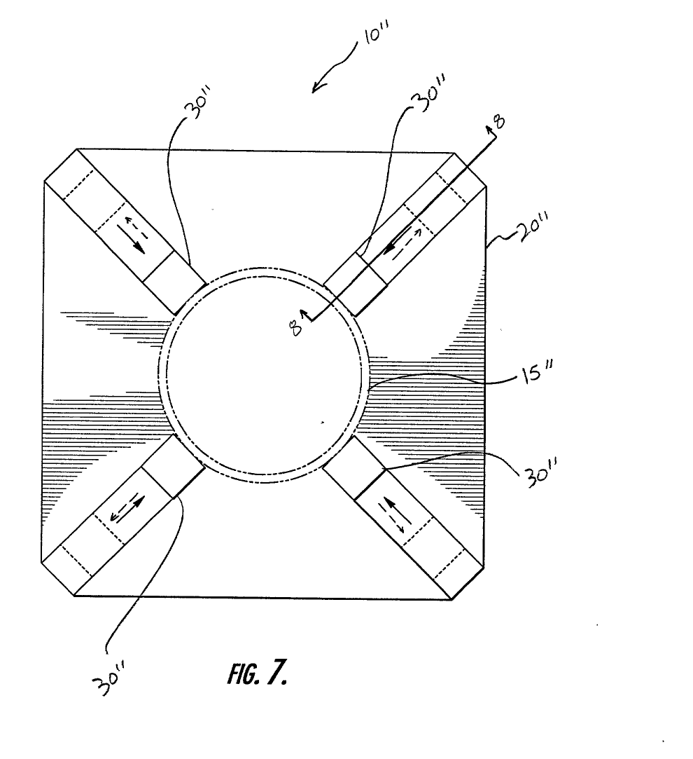

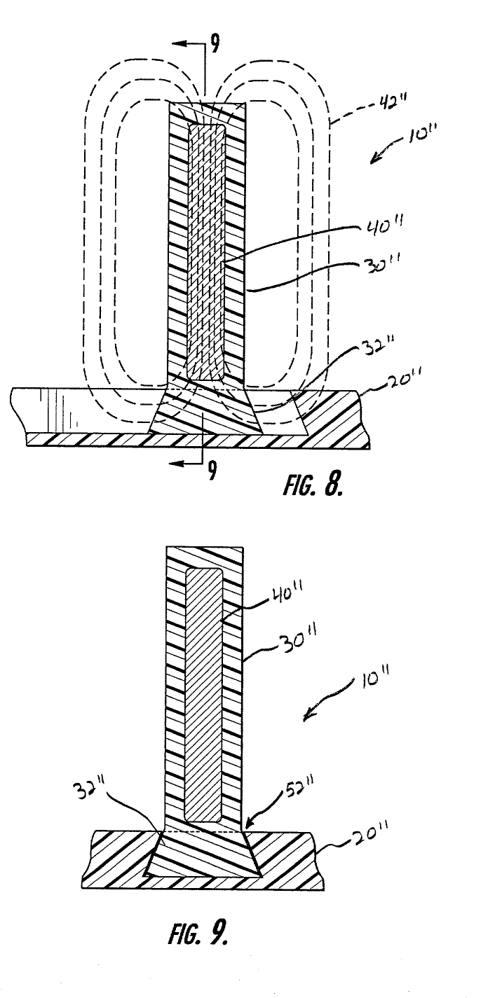

Turning now additionally to FIGS. 6-9, yet another embodiment of the beverage flavor enhancing device 10″ is now described. In this embodiment, the tubular members 30″ are illustratively slidably positioned on the base 20″ to facilitate repositioning thereof to accommodate different sized beverage containers 15″. The base 20″ illustratively includes elongated slots 50″ formed therein to slidably receive respective ends 32″ of the tubular members 30″. Each slot 50″ and respective end 32″ illustratively form an elongated dovetail joint 52″ to thereby enhance the security of the tubular members 30″ within the slots.

In this embodiment of the device 10″ the tubular members 30″ are illustratively slidable between extended and retracted positions, and, more particularly, between an infinite number of positions between the extended and retracted positions. When positioned toward the extended positions, the tubular members 30″ are configured to receive a larger beverage container 15″ than when positioned toward the retracted positions. For example, when positioned toward the extended positions, a wine bottle may be readily positioned between the tubular members 30″. Also for example, when positioned toward the retracted position, a beverage container 15″ as small as a shot glass may be readily positioned between the tubular members 30″. This advantageously allows a user to treat beverages 16″ in any one of a number of different sized beverage containers 15″.

A method aspect of the present invention is for enhancing beverage flavor. The method comprises providing a device 10, 10′, 10″ including a base 20, 20′, 20″ a plurality of spaced-apart tubular members 30, 30′, 30″ extending upwardly from the base 20, 20″, 20″ and at least one permanent magnet 40, 40′, 40″ within each of the tubular members. The method also includes positioning a beverage container on the base and between the spaced-apart tubular members to expose a beverage in the beverage container to a magnetic field to thereby enhance beverage flavor. In some embodiments as shown in FIGS. 6-9, the method also includes slidably positioning the tubular members 30″ on the base 20″ to accommodate a size of the beverage container 15″.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and embodiments are intended to be included within the scope of the appended claims.

That which is claimed is:

1. A beverage flavor enhancing device for use with a beverage container, the beverage flavor enhancing device comprising:
a base;
a plurality of tubular members extending upwardly from said base and arranged in spaced-apart relation to receive the beverage container therebetween when the beverage container is positioned on said base; and
at least one permanent magnet within each of said tubular members to generate a magnetic field within the beverage container to thereby enhance the beverage flavor.

2. A device according to claim 1 wherein said tubular members are arranged along points of an imaginary cylinder sized to receive the beverage container.

3. A device according to claim 2 wherein said tubular members are at least three in number.

4. A device according to claim 2 wherein said base has a generally polygonal shape; and wherein said tubular members are positioned adjacent respective vertices of the polygonally shaped base.

5. A device according to claim 4 wherein said polygonal shape comprises a square.

6. A device according to claim 4 wherein said polygonal shape comprises an equilateral triangle.

7. A device according to claim 1 wherein said tubular members are fixed to said base.

8. A device according to claim 7 wherein said base and said tubular members are integrally formed as a monolithic unit.

9. A device according to claim 1 wherein said tubular members are slidably positioned on said base to facilitate repositioning thereof to accommodate different sized beverage containers.

10. A device according to claim 9 wherein said base has elongated slots formed therein to slidably receive respective ends of said tubular members.

11. A device according to claim 10 wherein each slot and respective end form an elongated dovetail joint.

12. A device according to claim 1 wherein said base and said tubular members comprise nonmagnetic material.

13. A device according to claim 1 wherein said base and said tubular members comprise plastic.

14. A device according to claim 1 wherein said permanent magnets comprises neodymium.

15. A beverage flavor enhancing device for use with a beverage container, the beverage flavor enhancing device comprising:
a base;
at least three tubular members integrally formed with said base and extending upwardly therefrom, said tubular members arranged in spaced-apart relation to receive the beverage container therebetween when the beverage container is positioned on said base; and
at least one permanent magnet within each of said tubular members to generate a magnetic field within the beverage container to thereby enhance the beverage flavor.

16. A device according to claim 15 wherein said tubular members are arranged along points of an imaginary cylinder sized to receive the beverage container.

17. A device according to claim 15 wherein said base has a generally polygonal shape; and wherein said tubular members are positioned adjacent respective vertices of the polygonally shaped base.

18. A device according to claim 17 wherein said polygonal shape comprises a square.

19. A device according to claim 17 wherein said polygonal shape comprises an equilateral triangle.

20. A device according to claim 15 wherein said base and said tubular members comprise nonmagnetic material.

21. A device according to claim 15 wherein said base and said tubular members comprise plastic.

22. A device according to claim 15 wherein said permanent magnets comprises neodymium.

23. A beverage flavor enhancing device for use with a beverage container, the beverage flavor enhancing device comprising:
a base;
at least three tubular members extending upwardly from said base and arranged in spaced-apart relation to receive the beverage container therebetween when the beverage container is positioned on said base;
said tubular members slidably positioned on said base to facilitate repositioning thereof to accommodate different sized beverage containers; and
at least one permanent magnet within each of said tubular members to generate a magnetic field within the beverage container to thereby enhance the beverage flavor.

24. A device according to claim 23 wherein said tubular members are arranged along points of an imaginary cylinder sized to receive the beverage container.

25. A device according to claim 23 wherein said base has a generally polygonal shape; and wherein said tubular members are positioned adjacent respective vertices of the polygonally shaped base.

26. A device according to claim 23 wherein said polygonal shape comprises a square.

27. A device according to claim 23 wherein said polygonal shape comprises an equilateral triangle.

28. A device according to claim 23 wherein said base has elongated slots formed therein to slidably receive respective ends of said tubular members.

29. A device according to claim 28 wherein each slot and respective end form an elongated dovetail joint.

30. A device according to claim 23 wherein said base and said tubular members comprise nonmagnetic material.

31. A device according to claim 23 wherein said base and said tubular members comprise plastic.

32. A device according to claim 23 wherein said permanent magnets comprises neodymium.

33. A method for enhancing beverage flavor comprising:
providing a device comprising a base, a plurality of spaced-apart tubular members extending upwardly from the base, and at least one permanent magnet within each of the tubular members; and
positioning a beverage container on the base and between the spaced-apart tubular members to expose a beverage in the beverage container to a magnetic field to thereby enhance beverage flavor.

34. A method according to claim 33 wherein the tubular members are positioned along points of an imaginary cylinder sized to receive the beverage container.

35. A method according to claim 34 wherein the tubular members are at least three in number.

36. A method according to claim 33 wherein the tubular members are slidably positioned on the base; and further comprising slidably positioning the tubular members on the base to accommodate a size of the beverage container.

37. A method according to claim 33 wherein the base and the tubular members comprise plastic.

38. A method according to claim 33 wherein the permanent magnets comprises neodymium.

39. A method according to claim 33 wherein the beverage container contains a dairy product beverage.

40. A method according to claim 33 wherein the beverage container contains an alcoholic beverage.

41. A method according to claim 33 wherein the beverage container contains a citrus juice beverage.
